(19) United States
(12) Patent Application Publication
(10) Pub. No.: US 2005/0165430 A1
(43) Pub. Date: Jul. 28, 2005

(54) Atherectomy head and atherectomy catheter using the same

(76) Inventor: Hiroshi Kono, Kobe-City (JP)

Correspondence Address: KUBOVCIK & KUBOVCIK, SUITE 710, 900 17TH STREET NW, WASHINGTON, DC, 20006, US

(21) Appl. No.: 11/038,427

(22) Filed: Jan. 21, 2005

(30) Foreign Application Priority Data
Jan. 23, 2004 (JP) 2004-015503

(51) Int. Cl. A61D 1/02

(52) U.S. Cl. 606/159

(57) ABSTRACT

Provided is an atherectomy catheter, including a cylindrical catheter body, a freely rotatable drive wire inserted into an inside of the catheter body, and a head for removing a thrombus, which is provided on a tip of the catheter body, in which the head has an elastic member formed of a material that is deformable by collision with the thrombus, and an outer surface of the elastic member is placed on substantially the same level as a surface of a blade for removing the thrombus, or protrudes outwardly from the surface of the blade. The outer surface of the elastic member is dented backward from the surface of the blade of a blade member, or concaved by collision with the thrombus, the blade then abuts on the thrombus present in the concave formed, and the thrombus is eliminated.

### BACKGROUND OF THE INVENTION

1. Field of the Invention

The present invention relates to an atherectomy head for eliminating and removing a thrombus deposited in a blood vessel, and to an atherectomy catheter having the atherectomy head connected to a tip thereof.

2. Description of the Related Art

In order to remove a thrombus deposited in a blood vessel (hereinafter simply “vessel”), a guide wire is inserted into the vessel through tissue of a patient and advanced along the blood vessel to a position of the thrombus to be removed, and after the catheter reaches the thrombus, the guide wire is removed from the vessel. Subsequently, the thrombus is broken or dissolved by use of the catheter left in the vessel. Thereafter, the broken or dissolved thrombus is aspirated into the catheter. Thus, the thrombus is removed from the body of the patient. As a method for partially or entirely dissolving the thrombus, a thrombolytic agent such as streptokinase is injected into an area of the thrombus from a tip of the catheter. This method uses a large amount of the thrombolytic agent in expectation that the thrombolytic agent is diluted with blood. Accordingly, this method may cause bleeding, and adversely affects the other organs.

In addition to a method for breaking or dissolving the thrombus, there is a method of expanding a balloon provided on the tip of the catheter to expand the vessel, thereby restoring blood flow (PTCA method). However, according to this method, more pressure than necessary is applied to an inner wall of the vessel over an entire length of the balloon, and damage of the vessel is caused, which may trigger a further formation of a thrombus (i.e., restenosis). In order to prevent such restenosis, a stent is indwelled in the vessel. However, such indwelling of a stent for a long time may bring a risk of causing the thrombus again.

As a method for breaking a thrombus using a catheter, various methods have been proposed, such as a method of providing a spray nozzle on the tip of the catheter to spray water therefrom to break the thrombus, a method of breaking the thrombus by a laser beam, and a method of repeatedly colliding, with the thrombus, a catheter head composed of wires expandable into an umbrella shape from the tip of the catheter to break the thrombus. However, each of the above-mentioned methods has merits and demerits, and a satisfactory measure to break the thrombus has not yet been obtained. Besides such thrombus breaking measures as proposed above, an atherectomy catheter (trade name: Rotablader, made by Boston Scientific Corporation) to be described below is commercially available. In this atherectomy catheter, a head having a cutter composed of a file-shaped body having diamond powder embedded in the outer surface of a stainless steel body is attached onto a tip of a wire, and the head is rotated at an extremely high speed. Thus, the atherectomy catheter pulverizes the thrombus into particles not larger than erythrocytes, absorbs the particles into phagocytes, and discharges the particles to the outside of the body through the liver.

In this atherectomy catheter, the head having the cutter, which is attached onto the tip of the wire, collides with the thrombus while the file-shaped stainless steel body having the diamond powder embedded therein is rotating at the high speed, thereby removing the thrombus. Accordingly, there is a risk that the head collides not only with the thrombus but also with the inner wall of the vessel and damages the vessel, and a highly skilled treatment technique is required.

As means for solving such problems, atherectomy catheters which are intended to remove the thrombus without damaging the vessel by attaching the following heads onto the tips of the wires have been introduced. The heads are: one which includes a semicircular-blade (i.e., a half-circular fan) made of an elastic material on a surface of an elimination member having the diamond powder embedded in an elastic plastic material or stainless steel (refer to JP 07-79985 A); and one which includes protruded stripes composed of an elastic material or a hard, or rigid, material provided on a surface of a semicircular plastic member having diamond powder embedded therein at equal intervals (refer to JP 07-108044 A).

In these atherectomy catheters, the half-circular fan and the protruded stripes which are made of the elastic materials or the rigid materials are provided on the surfaces of the file-shaped elimination members in heads attached onto the tips of wires. Accordingly, as compared with an ablation member composed only of the file-shaped member having the diamond powder embedded therein, the risk of damaging the inner wall of the vessel is lowered in these atherectomy catheters. However, the half-circular fan and the protruded stripes which are made of the elastic materials are easily abraded. Further, each surface of the file-shaped elimination members, which eliminates the thrombus, projects outwardly from a micro viewpoint, and accordingly, these atherectomy catheters have a drawback of damaging the inner wall of the vessel in the case of moving in the vessel while the elimination members are rotating. Moreover, when the thrombus is to be removed by use of these catheters in the case where the thrombus is formed only on one surface of the inner wall of the vessel, these catheters have a risk of damaging the other surface of the inner wall of the vessel where the thrombus is not formed because the catheters are advanced in the vessel in a state where the same counter pressure is applied to the cross section of the catheter.

### SUMMARY OF THE INVENTION

The present invention has been made to solve the above-mentioned problems inherent in the conventional atherectomy catheters. Therefore, the present invention has as objects providing an atherectomy head capable of eliminating the thrombus with a number of revolutions, which is smaller than the number of revolutions (200,000 r.p.m.) of the head of the commercially available Rotablader, and is preferably from 2,000 r.p.m. to 20,000 r.p.m., and without damaging the inner wall of the vessel, and also providing an atherectomy catheter having the atherectomy head connected to a tip thereof.

In order to achieve the above objects, according to a first aspect of the present invention, there is provided an atherectomy head, including: a blade for eliminating a thrombus; a blade member including the blade; and an elastic member formed of a material that is deformed by collision with a thrombus, the elastic member including an outer surface which is substantially even with the surface of the blade or protrudes outwardly beyond the surface of the blade at the outer surface where the elastic member is near or contiguous to the blade, wherein the outer surface of the elastic member is forced backward from the surface of the blade by the collision with the thrombus to form a depression, and the blade of the blade member abuts on the thrombus present in the depression to eliminate, or remove, the thrombus.

Further, in the atherectomy head according to the first aspect of the present invention, a groove for aspirating the eliminated thrombus into an inside of a catheter is formed.

Further, in the atherectomy head according to the first aspect of the present invention, the outer surface of the elastic member is coated with a coating member made of a material that is not deformed by the collision with the thrombus, and the edge of blade is in contact with the coating member. The blade can be prevented from biting into the elastic member, and the elastic member can be prevented from being abraded by a thrombus that has been subjected to calcification.

Further, in the atherectomy head according to the first aspect of the present invention, at least two blades are provided as the blade.

Further, in the atherectomy head according to the first aspect of the present invention, the elastic member is a resilient spring board.

According to a second aspect of the present invention, there is provided an atherectomy catheter, including: a cylindrical catheter body; a freely rotatable wire inserted into an inside of the catheter body; aspirating means for aspirating a removed (eliminated) thrombus into the inside of the catheter body; and the atherectomy head described above, which is provided on a tip of the atherectomy catheter.

Further, in the atherectomy catheter according to the second aspect of the present invention, the atherectomy catheter is composed such that a visor-like member is provided on the exposed tip of the catheter body, and that the atherectomy head is provided on the tip of the catheter. By providing the visor-like member on the exposed tip of the catheter body, when a thrombus adhered onto only one surface of the inner wall of the vessel is removed, the other surface of the inner wall of the vessel can be prevented by the visor-like member from being damaged by the blade of the head.

According to another aspect of the present invention, there is provided an atherectomy catheter, including: a freely rotatable hollow cylindrical wire; rotating means for rotating the cylindrical wire, the rotating means being provided on a rear end thereof; aspirating means for aspirating a removed thrombus into an inside of the cylindrical wire, the aspirating means being provided on a rear end thereof; and the atherectomy head described above, which is provided on a tip of the cylindrical wire.

According to yet another aspect of the present invention, there is provided an atherectomy catheter, comprising: a freely rotatable cylindrical catheter body made of polymer containing fibers; rotating means for rotating the catheter body, the rotating means being provided on a rear end thereof; aspirating means for aspirating a removed thrombus into an inside of the catheter body, the aspirating means being provided on a rear end thereof; and the atherectomy head described above, which is provided on a tip of the catheter body. As the fiber material, glass fiber, stainless steel fiber, and carbon fiber can be used. Also, as the polymer, polyethylene, polypropylene, polyester, polyvinylchroride, Teflon (registered trademark), polyphenylenesulfide, and polyamide can be used. The content of the fiber in the polymer is 10% to 40% in weight.

According to even yet another aspect of the present invention, there is provided an atherectomy catheter, comprising: a freely rotatable cylindrical catheter body made of polymer containing a mesh; rotating means for rotating the catheter body, the rotating means being provided on a rear end thereof; aspirating means for aspirating a removed thrombus into an inside of the catheter body, the aspirating means being provided on a rear end thereof; and the head described above, which is provided on a tip of the catheter body. As the mesh material, stainless steel, glass, and carbon can be used. Also, as the polymer, polyethylene, polypropylene, polyester, polyvinylchroride, Teflon (registered trademark), polyphenylenesulfide, and polyamide can be used.

As described above, in the head of the present invention, the elastic member provided together with the blade member for removing the thrombus collides with the thrombus. Thus, the elastic member is deformed, and the outer surface of the elastic member is slightly forced backward from the surface of the blade of the blade member. The thrombus gets into the step difference thus formed and the blade of the blade member strikes the thrombus. Next, the thrombus is cut and removed by the blade of the revolving catheter head. Meanwhile, even if the tip of the head collides with a surface softer than the elastic member, such as the inner wall of the vessel, the elastic member is not deformed. Accordingly, even if the head rotates, the blade of the blade member does not bite into the wall of the vessel. Moreover, the blade eliminates the thrombus inward of the catheter. Accordingly, even if the head is one in which a gap is formed between the blade and the elastic member, the elastic member performs a protection function for the wall of the vessel, and the blade does not bite into the wall of the vessel. As a result, the atherectomy catheter of the present invention can eliminate the thrombus deposited in the vessel without damaging the wall of the vessel. Heretofore, when it was attempted to remove a thrombus by inserting a catheter into a vessel in which a thrombus is adhered onto only one surface of the inner wall, the other surface of the inner wall onto which the thrombus is not adhered was liable to be damaged. However, such a problem is solved by providing the visor-like member on the exposed tip of the catheter body.

### BRIEF DESCRIPTION OF THE DRAWINGS

FIG. 1 is a partially cut away side view of an atherectomy catheter of the present invention.

FIG. 2 is a partially cutaway side view showing another embodiment of the atherectomy catheter of the present invention.

FIG. 3(a) is a schematic side view showing another embodiment of the atherectomy catheter of the present invention.

FIG. 3(b) is a schematic plan view of FIG. 3(a).

FIG. 4 is a partially cutaway schematic view showing another embodiment of the atherectomy catheter of the present invention.

FIG. 5 is a partially cutaway schematic view showing another embodiment of the atherectomy catheter of the present invention.

FIG. 6 is a partially cutaway side view showing another embodiment of the atherectomy catheter of the present invention.

FIG. 7 is a side view of an atherectomy catheter in which a guide wire is inserted into a hollow portion of the hollow drive wire of FIG. 6.

FIG. 8 is a plan view of the head of the catheter of FIG. 1, viewed from a bottom, or back side, thereof.

FIG. 9 is a side view of the head viewed from an opposite side of the side view of the head of the catheter of FIG. 1.

FIG. 10 is a plan view of the tip bearing of the catheter of FIG. 1, viewed from a tip thereof.

FIG. 11 is a side view of a head in which a coating member is provided on an outer surface of an elastic member.

FIG. 12 is a side view of the head viewed from an opposite side of the side view of the head of FIG. 11.

FIG. 13 is a plan view of the head of FIG. 11 viewed from a bottom thereof.

FIG. 14 is a plan view of a head viewed from a bottom thereof, showing another embodiment different from that of FIG. 13.

FIG. 15 is a plan view of a head viewed from a bottom thereof, showing another embodiment different from that of FIG. 14.

FIG. 16 is a side view of a head, in which a gap is provided between a surface of a blade and an outer surface of an elastic member, and the surface of the blade and the tip surface of the elastic member are formed at substantially the same height.

FIG. 17 is a side view of the head viewed from an opposite side of the side view of the head of FIG. 16.

FIG. 18 is a plan view of the head of FIG. 16, viewed from a bottom thereof.

FIG. 19 is a plan view of a head viewed from a bottom thereof, in which a pair of blades and a pair of elastic members are placed at positions substantially orthogonal to each other, and spaces are formed between a blade member and the elastic members, which are adjacent to each other.

FIG. 20 is a side view of the head of FIG. 19.

FIG. 21 is a plan view of a head having eight blades, viewed from a bottom thereof.

FIG. 22 is a plan view of a head in which a spring board is used, viewed from a bottom thereof.

FIG. 23 is a side view of the head of FIG. 22.

FIG. 24 is a plan view of a head of another example different from that of FIG. 22, viewed from a bottom thereof.

### DETAILED DESCRIPTION OF THE PREFERRED EMBODIMENTS

Embodiments of the present invention will be described below based on the drawings.

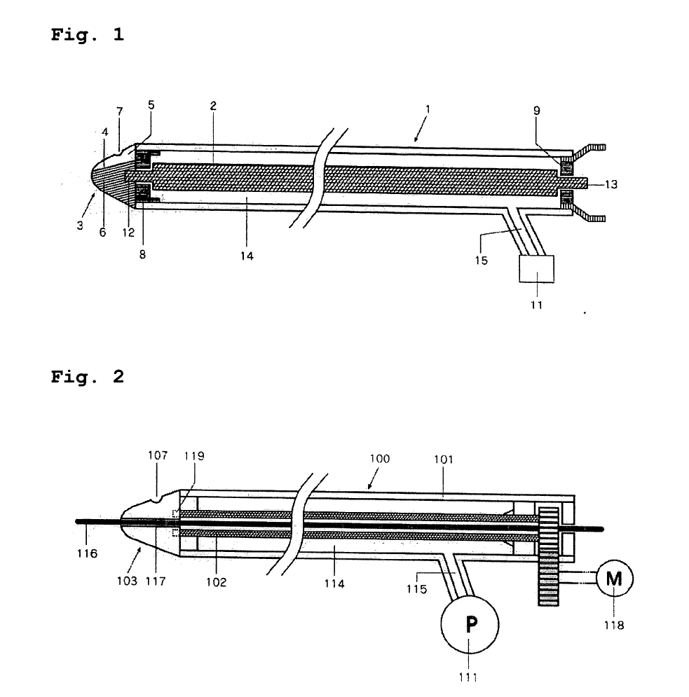

FIG. 1 is a partially cutaway side view of an atherectomy catheter of the present invention. The atherectomy catheter of the present invention includes a cylindrical catheter body 1, a freely rotatable drive wire 2 inserted into an inside 14 of the catheter body 1, a head 3 for eliminating, or removing, a thrombus, which is provided on a tip of the catheter body 1, and aspirating means 11 for aspirating the eliminated thrombus into the inside 14 of the catheter body 1. The head 3 is composed of a blade member 5 having a blade 4 for eliminating the thrombus, and an elastic member 6 made of a material deformable by collision with the thrombus. An outer surface of the elastic member 6 is depressed by the collision with the thrombus and moves inwardly of the blade 4 of the blade member 5, and the blade 4 of the head eliminates the thrombus present in the depression.

On a rear end side of the catheter body 1, the aspirating means 11, such as a vacuum device and a syringe, is placed. The aspirating means 11 produces a negative pressure in the inside 14 of the catheter body 1, and the eliminated thrombus is aspirated from a groove 7 formed on an outer surface of the head through a hole 17 of a tip bearing 8, which is shown in FIG. 10, into the inside 14 of the catheter body 1, and then aspirated from a passage 15 into the aspirating means 11. As the elastic material, a non rigid plastic, a rubber-like substance or the like, such as polyvinyl chloride, polyurethane, and nylon can be used. The elastic material preferably has a JIS-A hardness of 30 to 85 measured according to Durometer hardness test of JIS-K-6253.

The catheter body 1 is a hollow cylindrical tube which is formed of a flexible material such as polyvinyl chloride, polyurethane, nylon or Teflon (registered trademark), with both ends open. The catheter body 1 is capable of advancing or moving backward in an inside of a vessel so as to be freely slidable. The drive wire 2 is formed of stainless steel such as SUS304, and is inserted into the inside 14 of the catheter body 1. A rear end 13 of the drive wire 2 protrudes from a rear end bearing 9 provided on a rear end of the catheter body 1 to be connected to a motor, making the drive wire 2 rotatable. Moreover, a tip 12 of the drive wire 2 protrudes forward from the tip bearing 8 provided on the tip of the catheter body 1. The tip 12 is connected by an adhesive or the like to a hole 16 formed in the head 3, which is shown in FIG. 8, through a hole portion 10 of the tip bearing 8, which is shown in FIG. 10. The connection of the drive wire 2 and the head 3 may also be made by screwing, engaging and welding. Moreover, a discharge of thrombus waste can be assisted by providing a helical rib on an outer surface of the drive wire 2.

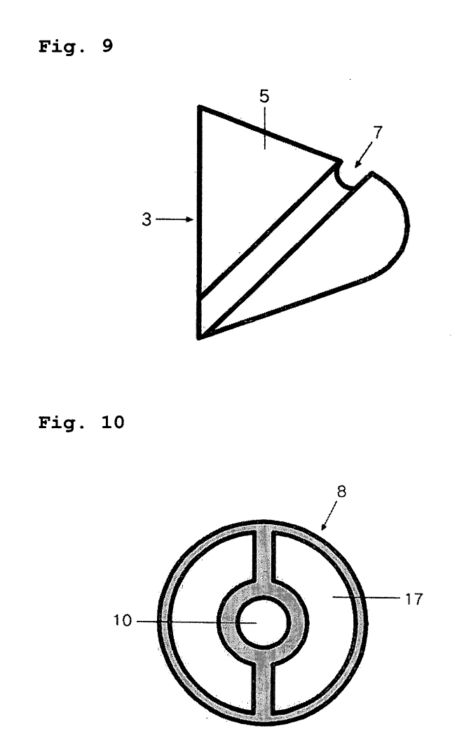

FIG. 8 is a plan view of the head of the catheter of FIG. 1, viewed from a bottom, or rear side, thereof, and FIG. 9 is a side view of the head viewed from an opposite side of the side view of the head of the catheter of FIG. 1. The head 3 is formed of the hard blade member 5 and the elastic member 6. The blade member 5 has the sharp blade 4 for eliminating the thrombus and is composed of titanium, stainless steel or the like. The elastic member 6 is composed of a material deformable into a concave shape by collision with the thrombus, that is, is a softer material than the thrombus, for example, polyurethane, vinyl chloride, nylon, silicone or the like. On the head 3, a groove 7 for aspirating the eliminated thrombus into the inside 14 of the catheter body 1 is formed. It is preferable that the groove 7 be formed in the blade member 5. It is preferable that the head 3 have a conical shape, a hemispherical shape or the like. The head 3 is formed in such a manner that the blade member 5 having the blade 4 and the elastic member 6 are in contact with each other. The outer surface of the elastic member 6 is in contact with the blade member 5 so as to be on substantially the same surface, i.e., the same level, as an outer surface of the blade member 5, that is, a surface of the blade 4, or to protrude forward, or outwardly, therefrom.

The elastic member 6 collides with the thrombus, and thus the elastic member 6 is depressed, or dented. The outer surface of the elastic member 6 is pushed backward from the surface of the blade 4 of the blade member 5 to form a concave, and the blade 4 of the blade member 5 of the rotating head 3 strikes the thrombus present in the concave, thereby eliminating the thrombus. The eliminated thrombus is aspirated from the groove 7 formed on the head 3 through the hole 17 of the tip bearing 8, which is shown in FIG. 10, into the inside 14 of the catheter body 1. The outer surface of the elastic member 6 and the outer surface of the blade member 5, that is, the surface of the blade 4, are in contact with each other on substantially the same level. As shown in FIG. 9, the groove 7 is provided on an outer surface of the blade member 5.

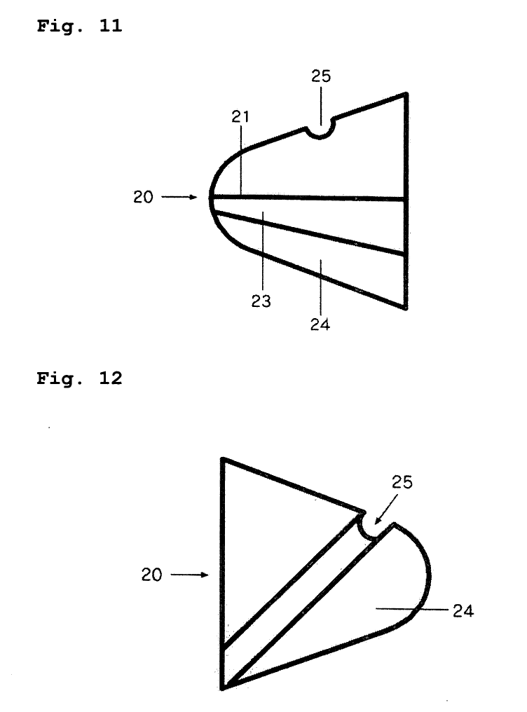

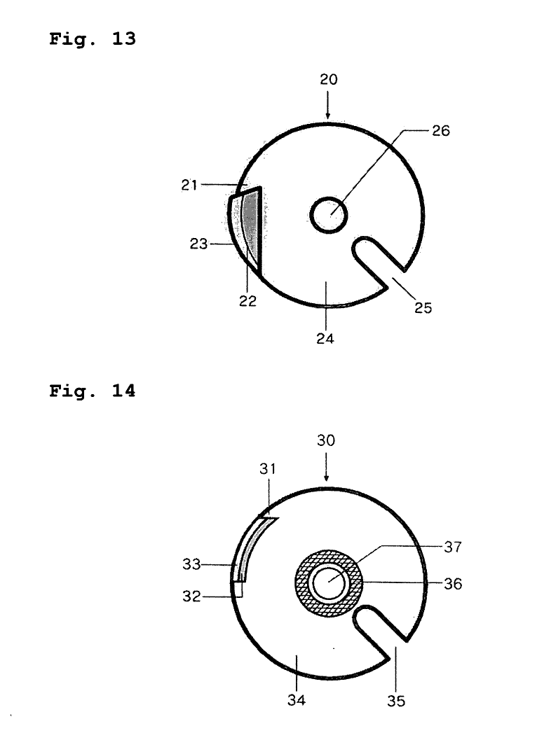

FIG. 11 is a side view of a head in which a coating member is provided on an outer surface of an elastic member, which is a side view of a head in which an outer surface of the coating member provided on the outer surface of the elastic member is formed more forward than, i.e., projects beyond, a surface of a blade. FIG. 12 is a side view of the head viewed from an opposite side of the side view of the head of FIG. 11. FIG. 13 is a plan view of the head viewed from a bottom, or rear side, thereof. A head 20 is composed by an outer surface of an elastic member 22 being coated with a coating member 23 formed of a material undeformed by collision with the thrombus. As a material of the coating member 23, a metal such as titanium or stainless steel, a plastic such as Teflon (registered trademark), and the like are preferable.

An outer surface of the coating member 23 provided on the outer surface of the elastic member 22 is formed at a position protruding forward, or outwardly beyond a surface of blade 21, and the surface of the blade 21 is formed in contact with the coating member 23. When the coating member 23 collides with a thrombus, the elastic member 22 is dented, or depressed, such that the tip surface of the coating member 23 is dented more than the surface of the blade 21, and the blade 21 of a blade member 24 of the rotating head 20 eliminates the thrombus present in the dent, that is, in the gap between the outer surface of the coating member 23 and the blade 21. The coating member 23 is provided on the elastic member 22 by an adhesive or the like, thus making it possible to prevent a risk that the blade 21 of the blade member 24 bites into the elastic member 22. The eliminated thrombus is aspirated from a groove 25 provided on an outer surface of the blade member 24 into the inside 14 of the catheter body 1. Reference numeral 26 of a center of the head of FIG. 13 denotes a hole of the head 20, which is adhered to the tip 12 of the drive wire 2. The head 20 is formed in such a manner that the coating member 23 provided on the outer surface of the elastic member 22 by an adhesive or the like is brought into contact with the surface of the blade 21, and the groove is formed on the blade member 24. Contact surfaces of the blade member 24 and the elastic member 22 other than the vicinity of the surface of the blade 21 are joined together by an adhesive or the like.

FIG. 14 is a plan view of a head viewed from a bottom, or rear side, thereof, showing another embodiment different from that of FIG. 13. FIG. 14 shows a head 30 in which an outer surface of a coating member provided on an outer surface of an elastic member is formed at substantially the same position as a surface of a blade. In the head 30, an outer surface of a coating member 33 provided on an outer surface of an elastic member 32 is formed at a position of which the height of the outer surface of the head, or radial position, is substantially the same as that of a surface of a blade 31, and the surface of the blade 31 is formed in contact with the coating member 33. The eliminated thrombus is aspirated from a groove 35 provided on an outer surface of blade member 34 into the inside of the catheter body. Reference numeral 37 of a center of the head 30 denotes a head passage 117 into which a guide wire 116 of an atherectomy catheter 100 of FIG. 2 is inserted, and reference numeral 36 denotes a hole for joining a head 103 and tip 119 of a hollow drive wire 102 of the atherectomy catheter 100 of FIG. 2 to each other by an adhesive or the like.

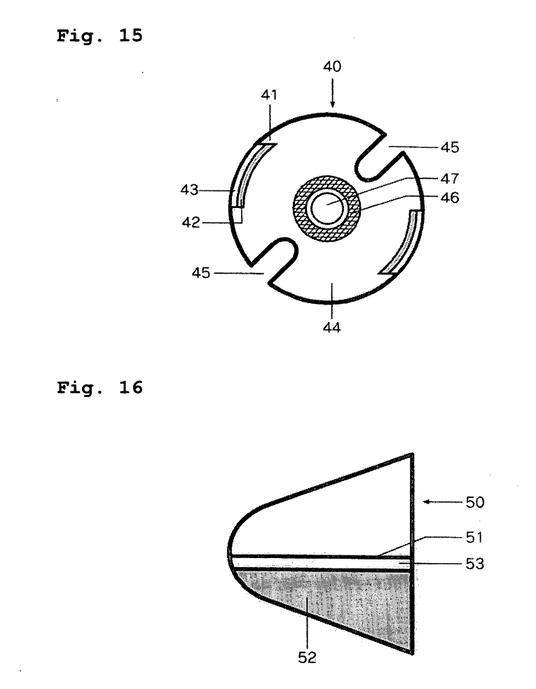

FIG. 15 is a plan view of a head viewed from a bottom, or rear side, thereof, showing another embodiment different from that of FIG. 14. FIG. 15 shows a head 40 in which an outer surface of a coating member provided on an outer surface of an elastic member is formed at substantially the same position, or level, as a surface of a blade and two grooves are provided. In the head 40, an outer surface of a coating member 43 provided on an outer surface of an elastic member 42 is formed at a position of which the height, or outermost position, is substantially the same as that of a surface of a blade 41, and the surface of the blade 41 is formed in contact with the coating member 43. When the coating member 43 collides with the thrombus, the elastic member 42 is dented, the outer surface of the coating member 43 is forced inwardly beyond the surface of the blade 41, and the blade 41 of the rotating head 40 eliminates the thrombus present in a gap formed between the outer surface of the coating member 43 and the surface of the blade 41. The eliminated thrombus is aspirated from the two grooves 45 provided on an outer surface of blade member 44 into the inside of the catheter body. Reference numeral 47 at a center of the head 40 denotes the head passage 117 into which the guide wire 116 of the atherectomy catheter 100 of FIG. 2 is inserted, and reference numeral 46 denotes a hole for joining the head 103 and tip 119 of the hollow drive wire 102 of the atherectomy catheter 100 of FIG. 2 to each other by an adhesive or the like.

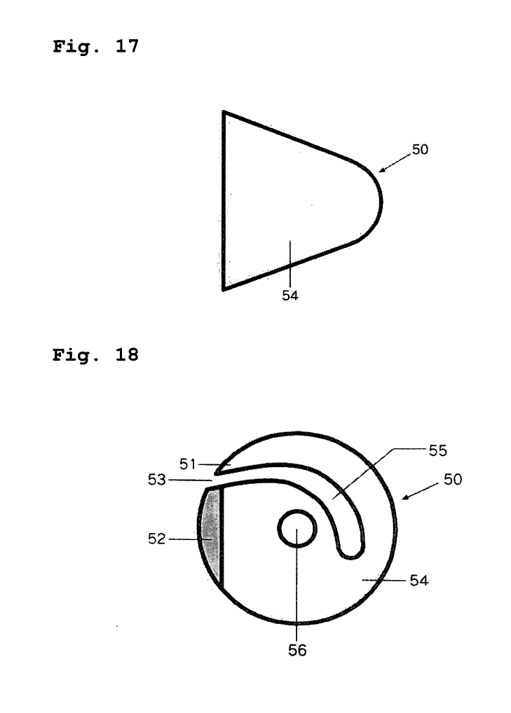

FIG. 16 is a side view of a head showing another example different from the above-described heads, in which a gap is provided between a surface of a blade and an outer surface of an elastic member, and the surface of the blade and the tip surface of the elastic member are formed at substantially the same height. FIG. 17 is a side view of the head viewed from an opposite side of the side view of the head of FIG. 16, and FIG. 18 is a plan view of the head of FIG. 16, viewed from a bottom, or rear side, thereof. In the head 50 of FIGS. 16 to 18, a surface of a blade 51 is formed in the same direction as a principal axis of the atherectomy catheter, and a gap 53 is formed between an outer surface of an elastic member 52 and the surface of the blade 51. Contact surfaces of the blade member 54 and the elastic member 52 other than the vicinity of the surface of the blade 51 are joined together by an adhesive or the like. A thrombus colliding with the head 50 is eliminated in an inward direction by the blade 51 of the rotating head 50. At this time, even if the head 50 collides with the inner wall of the vessel, the elastic member 52 is not dented because the inner wall of the vessel is softer than the elastic member 52. Thus, the elastic member 52 performs a protection function for the inner wall of the vessel, and does not damage the inner wall of the vessel. A groove 55 is provided from the gap 53 through an inside of the blade member 54 to the bottom of the head, and the thrombus falling into the gap 53 is aspirated from the groove 55 into the inside of the catheter body.

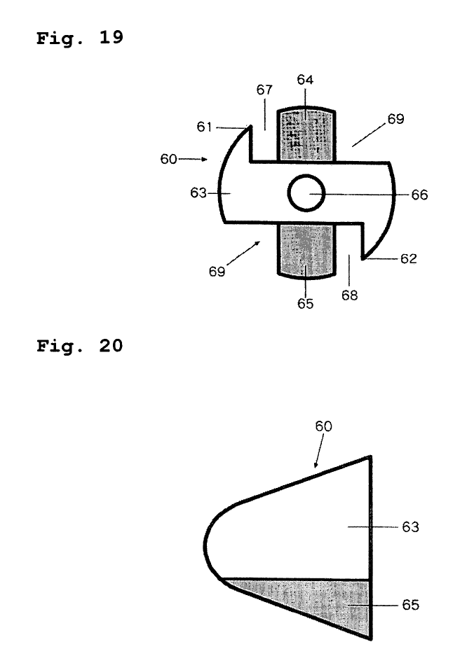

FIG. 19 is a plan view of a head viewed from a bottom, or rear, thereof, in which a pair of blades and a pair of elastic members are placed at positions substantially orthogonal to each other, and spaces are formed between the blade members and the elastic members, adjacent thereto. FIG. 20 is a side view of the head of FIG. 19. Head 60 is composed of a blade member 63 in which a blade 61 and a blade 62 are placed radially opposite to each other, and an elastic member 64 and an elastic member 65, which are placed at positions substantially orthogonal to the blade member 63. An eliminated thrombus is aspirated into the inside of the catheter body from a space 67 formed between the blade 61 and the elastic member 64, a space 68 formed between the blade 62 and the elastic member 65, and spaces 69 formed between the blade member 63 and the elastic members 64 and 65.

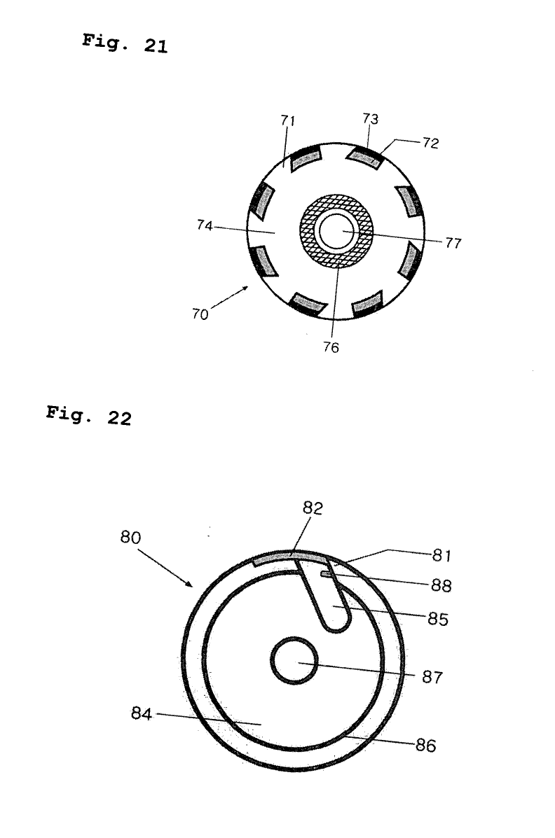

FIG. 21 is a plan view of a head having eight blades, viewed from a bottom, or rear, thereof. Head 70 is formed in the following manner. Eight blades 71 and eight layered products of elastic members 72 and coating members 73 provided on the outer surfaces of the_elastic members are arranged such that the outer surfaces of the coating members 73 are placed at positions of which the height, or radial position, is substantially the same as that of surfaces of the blades 71, and the surfaces of the blades 71 and the coating members 73 are brought into alternate contact with one another. When the coating members 73 collide with the thrombus, the elastic members 72 are concaved, the outer surfaces of the coating members 73 are concaved more than the surfaces of the blades 71, and the blades 71 of the rotating head 70 eliminate the thrombus present in the concaves, that is, the gaps between the tip surfaces of the coating members 73 and the surfaces of the blades 71. The head 70 is effective in the case of eliminating thrombus where calcification develops. However, in the head 70, no location for providing a groove which guides the eliminated thrombus into the inside of the catheter body is provided in blade member 74. Accordingly, unlike the heads of the other embodiments, no groove is formed in the head 70. Therefore, the eliminated thrombus floats in the vessel. Hence, by use of an atherectomy catheter 400 as shown in FIG. 5, in which a side hole 404 is provided on an outer circumference of a tip of a catheter body 401, the eliminated thrombus present in the vessel is aspirated from the side hole 404 into the inside of the catheter body. Reference numeral 77 at the center of the head 70 denotes a head passage 417 into which a guide wire 416 of the atherectomy catheter 400 of FIG. 5 is inserted. Reference numeral 76 denotes a hole for joining head 403 and tip 419 of a hollow drive wire 402 of the atherectomy catheter 400 of FIG. 5 to each other by an adhesive or the like.

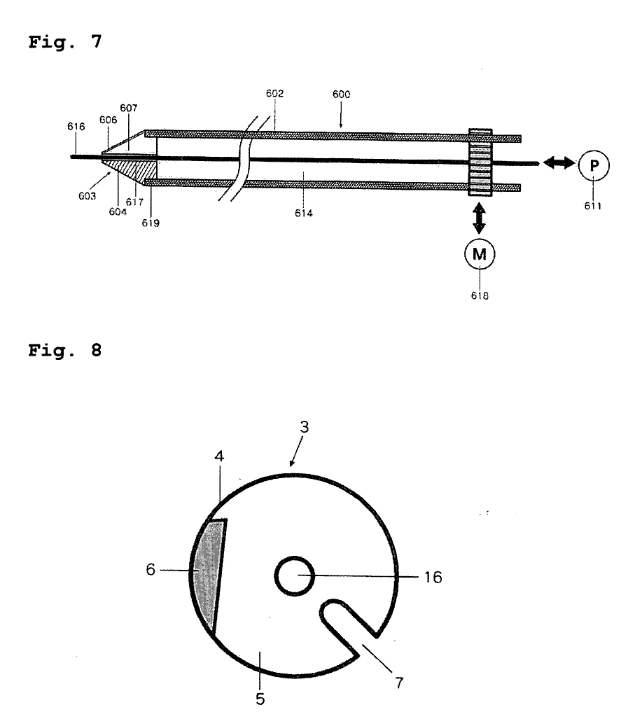

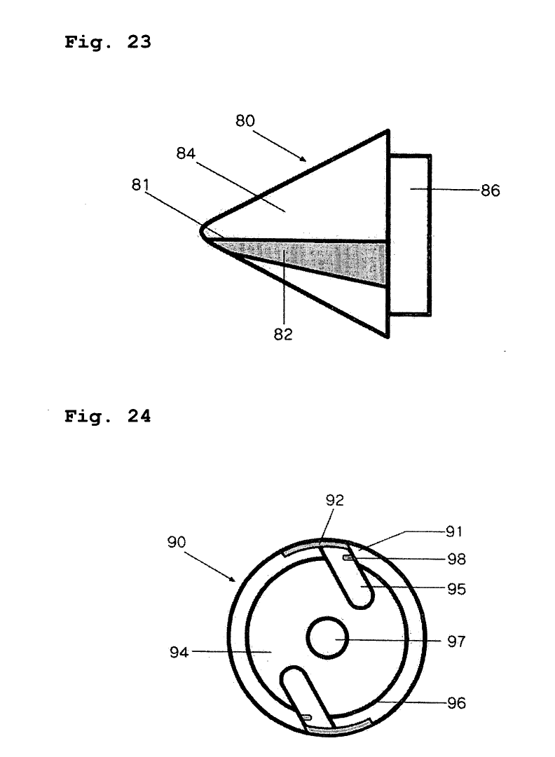

FIG. 22 is a plan view of a head in which a springboard-like elastic member is used, viewed from a bottom, or rear, thereof, and FIG. 23 is a side view of the head. The head is one in which a resilient springboard-like elastic member is used as an elastic member instead of an elastic material such as a nonrigid plastic or rubber-like substance. The head is a head 80 in which a surface of a blade and an outer surface of the springboard-like elastic member are formed to have substantially the same heights. The head 80 has a structure in which a springboard-like elastic member 82 is in contact with an outer surface of a surface side of a blade 81 and formed to cover a groove 85. When the springboard-like elastic member 82 collides with a thrombus, a tip of the springboard-like elastic member 82 is fixed more than a surface of the blade 81 and bent toward the groove 85 side, and the blade 81 of the rotating head 80 eliminates the thrombus present in a gap between the tip of the springboard-like elastic member 82 and the surface of the blade 81. A protrusion 88 is provided in the groove 85 for preventing the tip of the spring board-like elastic member 82 from bending too much and preventing a possibility that exposure of the surface of the blade 81 becomes large and that the surface of the blade 81 deeply bites into the thrombus. The protrusion 88 serves as a stopper. The eliminated thrombus is aspirated from the groove 85 provided in the blade member 84 into the inside of the catheter body. The springboard-like elastic member is an elastic metal which is in the form of a resilient thin plate. For the springboard-like elastic member, it is preferable to use stainless steel, a nickel-titanium alloy or the like. In FIG. 22, reference numeral 87 at the center of the head 80 denotes a head passage 617 into which a guide wire 616 of a hollow drive wire 602 of FIG. 7 is inserted. Reference numeral 86 of FIG. 22 denotes a convex portion for joining an inner wall of a tip 619 of the hollow drive wire 602 and a sidewall of a bottom of a head 603 of FIG. 7 to each other by an adhesive or the like.

FIG. 24 is a plan view of a head of another embodiment different from that of FIG. 22, viewed from a bottom, or rear, thereof. The head is a head 90 in which atherectomy portions are individually formed in two grooves 95. In each of the atherectomy portions, a surface of a blade and a tip surface of a springboard-like elastic member are formed to have substantially the same heights. In the grooves 95, protrusions 98 are individually formed. The head 90 has a structure in which springboard-like elastic members 92 are in contact with a tip of a surface side of a blade 91 and individually formed to cover the two grooves 95. When the springboard-like elastic members 92 collide with the thrombus, tips of the springboard-like elastic members 92 are flexed more than a surface of the blade 91 and bent toward the grooves 95 side, and the blade 91 of the rotating head 90 eliminates the thrombus present in gaps between the tips of the springboard-like elastic members 92 and the surface of the blades 91. The eliminated thrombus is aspirated from the grooves 95 provided on a blade member 94 into the inside of the catheter body. Reference numeral 97 at the center of the head 90 denotes the head passage 617 into which the guide wire 616 of the hollow drive wire 602 of FIG. 7 is inserted. Reference numeral 96 denotes a convex portion for joining the inner wall of the tip 619 of the hollow drive wire 602 and a sidewall of the bottom of the head 603 of FIG. 7 to each other by an adhesive or the like.

FIG. 2 is a partially cutaway side view showing another example of the atherectomy catheter of the present invention. The atherectomy catheter 100 includes a cylindrical catheter body 101, a freely rotatable hollow drive wire 102 inserted into an inside 114 of the catheter body 101, a head 103 for eliminating, or removing, a thrombus, and which is provided on a tip of the catheter body 101, and a vacuum pump 111 for aspirating the eliminated thrombus into the inside 114 of the catheter body 101. Into a hollow portion of the hollow drive wire 102, a guide wire 116 is inserted, and a tip thereof protrudes to the outside through a head passage 117 penetrating from a tip of the head 103 to a bottom thereof. Reference numeral 119 of the tip of the hollow drive wire 102 denotes a connecting portion of the hollow drive wire 102 and the head 103, which are connected to the head 103 by an adhesive or welding. The vacuum pump 111 placed on a rear end side of the catheter body 101 produces a negative pressure in the inside 114 of the catheter body 101, and the thrombus eliminated by the head 103 is aspirated from the inside 114 of the catheter body 101 through a passage 115 into the vacuum pump 111.

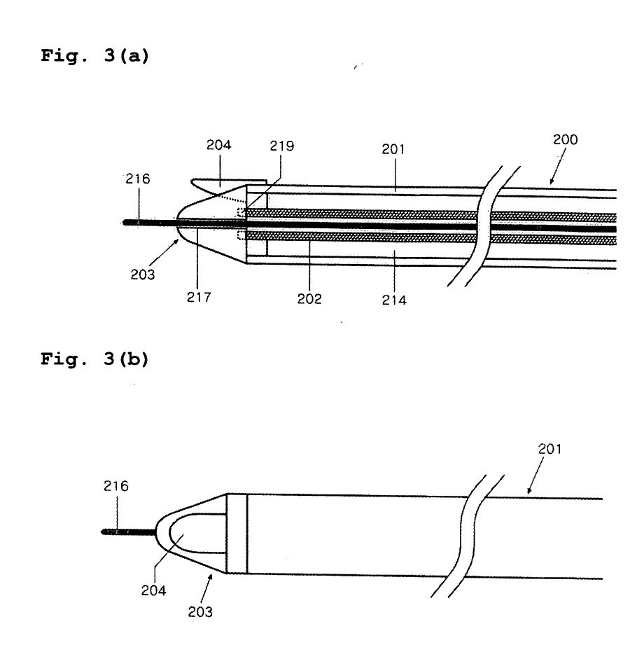

FIGS. 3(a) and 3(b) are partially cutaway views showing another embodiment of the atherectomy catheter of the present invention: FIG. 3(a) is a schematic side view; and FIG. 3(b) is a schematic plan view. FIGS. 3(a) and 3(b) show an atherectomy catheter 200 characterized in that a visor-like member 204 is placed on an exposed tip of a catheter body 201. The atherectomy catheter 200 includes the cylindrical catheter body 201, a freely rotatable hollow drive wire 202 inserted into an inside 214 of the catheter body 201, a head 203 for eliminating the thrombus, and which is provided on the tip of the catheter body 201, an aspiration device (not shown) for aspirating the eliminated thrombus into the inside 214 of the catheter body 201, and the visor-like member 204 placed on the open tip of the catheter body 201. Into a hollow portion of the hollow drive wire 202, a guide wire 216 is inserted, and a tip thereof protrudes to the outside through a head passage 217 penetrating from a tip of the head 203 to a bottom thereof. The visor-like member 204 is placed on the exposed tip of the catheter body 201. By providing the visor-like member 204 on the exposed tip of the catheter body 201, when a thrombus adhered onto only one inner wall of the vessel is eliminated, the other inner wall of the vessel is prevented by the visor-like member 204 from being damaged by a blade of the head 203. For the visor-like member 204, a thin plate made of metal, plastic or the like is used. Moreover, though the visor-like member 204 has a cap brim shape in FIG. 2, any shape can be adopted as long as the visor-like member 204 does not inhibit rotation of the head 203 and prevents the vessel from being damaged by the rotation thereof.

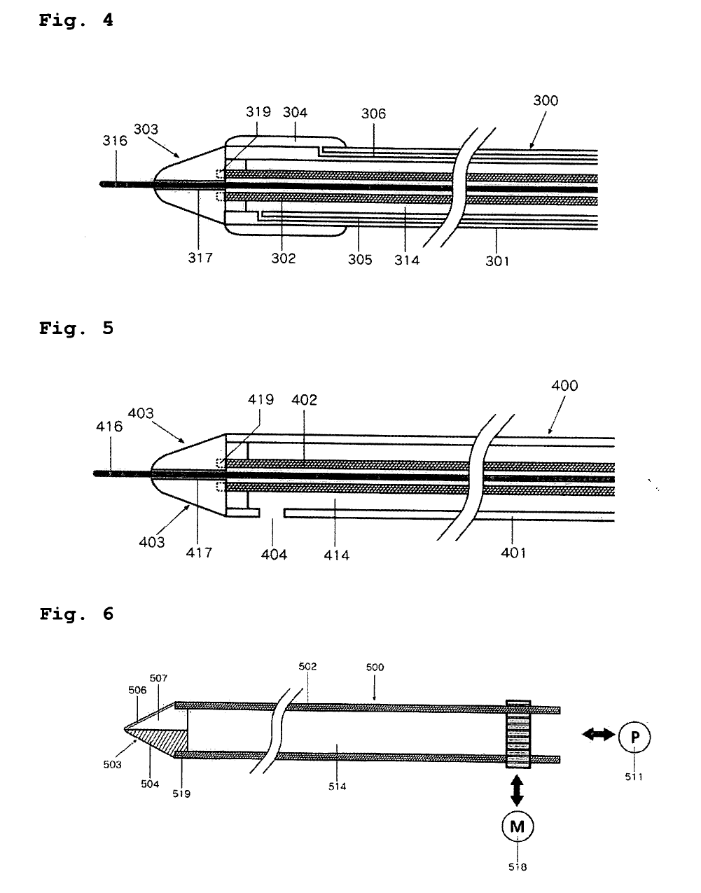

FIG. 4 is a partially cutaway schematic view showing another embodiment of the atherectomy catheter of the present invention. FIG. 4 shows an atherectomy catheter 300 characterized in that a balloon 304 is placed on an outer circumference of a tip of a catheter body 301, and that a coolant passage 305 for a coolant for cooling heat generated by a hollow drive wire 302 rotating in the catheter body 301 and for washing an inside 314 of the catheter body 301 is provided. The atherectomy catheter 300 is composed of the cylindrical catheter body 301, the freely rotatable hollow drive wire 302 inserted into the inside 314 of the catheter body 301, a head 303 for eliminating a thrombus, which is provided on a tip of the catheter body 301, an aspiration device (not shown) for aspirating the eliminated thrombus into the inside 314 of the catheter body 301, the balloon 304 provided on the outer circumference of the tip of the catheter body 301, and the coolant passage 305 provided on an inner circumference of the catheter body 301. A guide wire 316 is inserted into a hollow portion of the hollow drive wire 302, and a tip thereof protrudes to the outside through a head passage 317 penetrating from a tip of the head 303 to a bottom thereof. The balloon 304 can be expanded by a normal saline solution or the like which is supplied from a supply passage 306. The balloon 304 functions to maintain the vessel, to stabilize the catheter body 301 in the vessel for preventing a position of the head 303 from shaking, and to stop the flow of blood when needed. Moreover, the coolant passage 305 is provided on the inner circumference of the catheter body 301, and cools the heat generated by the rotating hollow drive wire 302. Furthermore, the coolant supplied from the coolant passage 305 is aspirated through the inside 314 of the catheter body 301 into the vacuum device (not shown) and, accordingly, functions to wash and eliminate the thrombus and the like which are aspirated into the inside 314 of the catheter body 301.

FIG. 5 is a partially cutaway schematic view showing another embodiment of the atherectomy catheter of the present invention. Atherectomy catheter 400 shown in FIG. 5 is optimum for the case of using the head 70 without any grooves, which is shown in FIG. 21, and is characterized in that a side hole 404 is provided on an outer circumference of a tip of a catheter body 401 to aspirate and remove eliminated thrombus present in the vessel from the side hole 404. The atherectomy catheter 400 is composed of the cylindrical catheter body 401, a freely rotatable hollow drive wire 402 inserted into an inside 414 of the catheter body 401, a head 403 for eliminating a thrombus, which is provided on the tip of the catheter body 401, a vacuum device (not shown) for aspirating eliminated thrombus into the inside 414 of the catheter body 401, and the side hole 404 provided on the outer circumference of the tip of the catheter body 401. A guide wire 416 is inserted into a hollow portion of the hollow drive wire 402, and a tip of the guide wire 416 protrudes to the outside through a head passage 417 penetrating from a tip of the head 403 to a bottom thereof. The head having eight blades, which is shown in the plan view of the head of FIG. 21, (viewed from the bottom thereof,) does not have a dead space for forming the grooves for removing the eliminated thrombus. Accordingly, the eliminated thrombus floats in the vessel. The thrombus concerned is aspirated from the side hole 404 provided on the outer circumference of the tip of the catheter body 401 into the inside 414, and is removed by the vacuum device (not shown).

FIG. 6 is a partially cutaway side view showing another embodiment of the atherectomy catheter of the present invention. Atherectomy catheter 500 includes a freely rotatable hollow drive wire 502, a head 503 for eliminating a thrombus, which is provided on a tip of the hollow drive wire 502, a vacuum pump 511 for aspirating eliminated thrombus into an inside 514 of the hollow drive wire 502, and a motor 518 for rotating the hollow drive wire 502. The head 503 has a structure in which a spring board-like elastic member 506 is in contact with a tip of a surface side of a blade (hidden and invisible in the drawing) and formed to cover a groove 507. When the springboard-like elastic member 506 collides with the thrombus, a tip of the springboard-like elastic member 506 is flexed more than the surface of the blade and bent toward the groove 507 side, and the blade of the rotating head 503 eliminates a thrombus present in a gap between the tip of the spring board 506 and the surface of the blade. The vacuum pump 511 placed on a rear end side of the hollow drive wire 502 produces a negative pressure in the inside 514 of the hollow drive wire 502, and the thrombus eliminated by the head 503 is aspirated from the groove 507 provided on a blade member 504 through the inside 514 of the hollow drive wire 502 into the vacuum pump 511.

FIG. 7 is a side view of an atherectomy catheter in which a guide wire 616 is inserted into a hollow portion of the hollow drive wire 502 of FIG. 6. Atherectomy catheter 600 includes a freely rotatable hollow drive wire 602, a head 603 for eliminating a thrombus, which is provided on a tip of the hollow drive wire 602, a vacuum pump 611 for aspirating the eliminated thrombus into an inside 614 of the hollow drive wire 602, and a motor 618 for rotating the hollow drive wire 602. A guide wire 616 is inserted into the hollow portion of the hollow drive wire 602, and a tip thereof protrudes to the outside through a head passage 617 penetrating from a tip of the head 603 to a bottom thereof. The vacuum pump 611 placed on a rear end side of the hollow drive wire 602 produces a negative pressure in the inside 614 of the hollow drive wire 602, and the thrombus eliminated by the head 603 is aspirated from a groove 607 provided in a blade member 604 through the inside 614 of the hollow drive wire 602 into the vacuum pump 611. Depending on an occlusion state of a thrombus in the vessel, the guide wire 616 is replaced by a guide wire having a file attached onto the tip of the guide wire 616 concerned, and a tip of the guide wire is slightly protruded from the head 603 and rotated together with the hollow drive wire 602, thus making it possible to eliminate the thrombus subjected to calcification. Moreover, the head of the present invention can be used by also being attached onto a tip of a catheter containing a mesh or fiber, in which the cylindrical body is made of plastic containing the mesh or fiber, instead of the catheter in which the cylindrical body of the hollow drive wire is made of stainless steel.

1. An atherectomy head for an atherectomy catheter, comprising:
a blade for eliminating a thrombus;
a blade member including the blade; and
an elastic member provided on a tip of said head and formed of a material that is deformable by collision with a thrombus, the elastic member including an outer surface which comprises one of a surface at substantially the same height on the head as a surface of the blade and a surface protruding outwardly beyond the surface of the blade,
wherein the elastic member is pushed backward from the surface of the blade by the collision with the thrombus to form a depression, and the blade of the blade member strikes the thrombus present in the depression to eliminate the thrombus.

2. The atherectomy head according to claim 1, further comprising a groove for aspirating the eliminated thrombus into an inside of the catheter.

3. The atherectomy head according to claim 2, wherein:
the outer surface of the elastic member is coated with a coating member made of a material that is not deformable by the collision with the thrombus; and
the blade is contiguous to the coating member.

4. The atherectomy head according to claim 1, wherein the elastic member comprises a resilient springboard-like elastic member.

5. The atherectomy head according to claim 2, wherein the elastic member comprises a resilient springboard-like elastic member.

6. The atherectomy head according to claim 1, wherein the blade comprises at least two blades.

7. The atherectomy head according to claim 2, wherein the blade comprises at least two blades.

8. An atherectomy catheter, comprising:
a cylindrical catheter body;
a freely rotatable wire inserted into an inside of the catheter body;
aspirating means for aspirating an eliminated thrombus into the inside of the catheter body; and
an atherectomy head provided on a tip of the catheter, said head comprising:
a blade for eliminating a thrombus;
a blade member including the blade;
a groove for aspirating the eliminated thrombus into an inside of the catheter; and
an elastic member provided on a tip of said head and formed of a material that is deformable by collision with a thrombus, the elastic member including an outer surface which comprises one of a surface at substantially the same height on the head as a surface of the blade and a surface protruding outwardly beyond the surface of the blade,
wherein the elastic member is pushed backward from the surface of the blade by the collision with the thrombus to form a depression, and the blade of the blade member strikes the thrombus present in the depression to eliminate the thrombus.

9. The atherectomy catheter of claim 8, wherein the outer surface of the elastic member of said atherectomy head is coated with a coating member made of a material that is not deformable by the collision with the thrombus; and
the blade is contiguous to the coating member.

10. The atherectomy catheter of claim 8, wherein the elastic member of said atherectomy head comprises a resilient springboard-like elastic member.

11. The atherectomy catheter according to claim 8, further comprising a visor-like member provided on the tip of the atherectomy catheter.

12. The atherectomy catheter according to claim 9, further comprising a visor-like member provided on the tip of the atherectomy catheter.

13. The atherectomy catheter according to claim 10, further comprising a visor-like member provided on the tip of the atherectomy catheter.

14. An atherectomy catheter, comprising:
a freely rotatable hollow cylindrical wire;
rotating means for rotating the cylindrical wire, the rotating means being provided on a rear end of the cylindrical wire;
aspirating means for aspirating an eliminated thrombus into an inside of the cylindrical wire, the aspirating means being provided on the rear end of the catheter; and
an atherectomy head provided on a tip of the catheter, said head comprising:
a blade for eliminating a thrombus;
a blade member including the blade;
a groove for aspirating the eliminated thrombus into an inside of the catheter; and
an elastic member provided on a tip of said head and formed of a material that is deformable by collision with a thrombus, the elastic member including an outer surface which comprises one of a surface at substantially the same height on the head as a surface of the blade and a surface protruding outwardly beyond the surface of the blade,
wherein the elastic member is pushed backward from the surface of the blade by the collision with the thrombus to form a depression, and the blade of the blade member strikes the thrombus present in the depression to eliminate the thrombus.

15. The atherectomy catheter of claim 14, wherein the outer surface of the elastic member of said atherectomy head is coated with a coating member made of a material that is not deformable by the collision with the thrombus; and
the blade is contiguous to the coating member.

16. The atherectomy catheter of claim 14, wherein the elastic member of said atherectomy head comprises a resilient springboard-like elastic member.

17. An atherectomy catheter, comprising:
a freely rotatable cylindrical catheter body made of plastic;
rotating means for rotating the catheter body, the rotating means being provided on a rear end of the catheter;
aspirating means for aspirating an eliminated thrombus into an inside of the catheter body, the aspirating means being provided on a rear end of the catheter; and
an atherectomy head provided on a tip of the catheter, said head comprising:
a blade for eliminating a thrombus;
a blade member including the blade;
a groove for aspirating the eliminated thrombus into an inside of the catheter; and
an elastic member provided on a tip of said head and formed of a material that is deformable by collision with a thrombus, the elastic member including an outer surface which comprises one of a surface at substantially the same height on the head as a surface of the blade and a surface protruding outwardly beyond the surface of the blade,
wherein the elastic member is pushed backward from the surface of the blade by the collision with the thrombus to form a depression, and the blade of the blade member strikes the thrombus present in the depression to eliminate the thrombus.

18. The atherectomy catheter of claim 17, wherein said plastic contains a fiber or a mesh.

19. The atherectomy catheter of claim 18, wherein the outer surface of the elastic member of said atherectomy head is coated with a coating member made of a material that is not deformable by the collision with the thrombus; and
the blade is contiguous to the coating member.

20. The atherectomy catheter of claim 18, wherein the elastic member of said atherectomy head comprises a resilient springboard-like elastic member.
